(19) United States
(12) Patent Application Publication
(10) Pub. No.: US 2012/0043708 A1
(43) Pub. Date: Feb. 23, 2012

(54) DAMPING ELEMENT HAVING A WAVY SUPPORTING RING

(75) Inventors: Thomas BURLAGE, Wallenhorst (DE); Jan WUCHERPFENNIG, Brockum (DE)

(73) Assignee: BASF SE, Ludwigshafen (DE)

(21) Appl. No.: 13/211,666

(22) Filed: Aug. 17, 2011

Related U.S. Application Data
(60) Provisional application No. 61/375,886, filed on Aug. 23, 2010.

(30) Foreign Application Priority Data
Aug. 20, 2010 (DE) 102010039621.4-12

(51) Int. Cl. F16F 7/00

(52) U.S. Cl. 267/141

(57) ABSTRACT

Damping element comprising a hollow cylindrical spring element (20) and also a supporting ring (10), the spring element (20) having, below the top end face (21), a peripheral depression (23) in the inner surface area (25), and the supporting ring (10) being mounted in this depression (23), wherein both the depression (23) and the outer margin of the supporting ring (12) are designed to be wavy in the radial direction, wave crests and wave troughs of the depression and supporting ring corresponding to one another in form, size and arrangement.

The present application includes by reference the prior U.S. application 61/375,886 filed on Aug. 23, 2010.

The present invention relates to a damping element comprising a hollow cylindrical spring element and also a supporting ring, the spring element having, below the top end face, a peripheral depression in the inner surface area, and the supporting ring being mounted in this depression. The invention relates, furthermore, to motor vehicles which are equipped with at least one damping element according to the invention.

Spring elements produced from polyurethane elastomers are used in motor vehicles, for example inside the chassis, and are generally known. They are employed particularly for vibration damping. They are used predominantly as an additional shock absorber in addition to the main shock absorber which is often based on metal springs or compressed gas elements. These spring elements are usually hollow bodies which are shaped concentrically and may have different diameters or wall thicknesses along the spring axis. These spring elements could basically also function as the main shock absorber, but often, in combination with the main shock absorber, assume a limit stop function. In this case, they influence the force/travel characteristic of the sprung wheel by generating or reinforcing a progressive characteristic of the vehicle suspension. Thus, the pitch effects of the vehicle can be reduced and rolling support can be reinforced. In particular, starting rigidity is optimized by means of the geometric configuration, this having a decisive influence upon the suspension comfort of the vehicle. The directed design of the geometry results in component properties which are virtually constant throughout the service life. This function increases driving comfort and ensures a maximum degree of driving safety.

On account of the widely varying characteristics and properties of individual automobile models, the spring elements have to be adapted individually to the various automobile models in order to achieve ideal chassis tuning. For example, the development of the spring elements may take into account the weight of the vehicle, the chassis of the special model, the shock absorbers provided and the desired spring characteristic. In addition, individual single solutions coordinated with the construction have to be developed for different automobiles on account of the available construction space.

Frequent stipulations relate to the spring length, the starting rigidity and the block dimension which constitutes the remaining spring height under a defined load, for example 30 kN with static loading or 35 kN with dynamic loading. In order to achieve a stipulated block dimension, supporting rings are often used which are attached to the actual damping element or surround the latter. Such supporting rings, which can be manufactured from hard materials, such as metals or hard plastics, or else from elastic materials, increase the block dimension in the desired way. Such supporting rings are known, for example, from the laid-open publication DE 101 24 924 A1 and utility model DE 20 2004 008 993 U1. These supporting rings have in common the fact that they are attached on from outside in an indentation of the spring element and consequently lead to a shortening of the spring travel. In many automobile models, however, the construction space is configured in such a way that no space is available for mounting an outer supporting ring according to the prior art.

A further possibility of increasing the block dimension is to provide a fastening pot at the upper end of the spring element. Such a design is known, for example from the laid-open publication DE 103 17 815 A1. The pot is manufactured from a harder material than the spring element and serves, on the one hand, for fastening in the housing of the body and, on the other hand, for limiting the spring travel. Even in this type of construction, however, it may happen that there is no room in the construction space for a pot. Furthermore, in this type of construction, there is no damping between the housing and spring element in the radial direction, since the pot has scarcely any damping properties. Moreover, at least the design disclosed in DE 103 17 815 A1 is complicated, since a prefabricated pot has to be filled with foam during the production of the spring element.

The object on which present invention was based is to provide a damping element which has required springing properties in the case of a limited block dimension, which can be produced simply and cost-effectively and which also exerts a damping action in the radial direction.

This object is achieved by means of the subject of the invention, as reproduced in claim 1. Further advantageous embodiments of the invention are found in the dependent claims. A further subject of the invention is motor vehicles which comprise one or more of the damping elements according to the invention.

According to the invention, the damping element comprises as essential components a hollow cylindrical spring element and also a supporting ring. Preferably, both components are essentially concentric in cross section. The two components may be configured differently in the longitudinal direction, the longitudinal direction being defined perpendicularly to the cross-sectional area. The terms “longitudinal axis”, “top” and “bottom” designate hereafter the orientation in which such spring elements are usually mounted, for example in motor vehicles, as additional springs in shock absorber systems.

Spring elements according to the invention may be produced from various elastic materials, for example rubber or foamed thermoplastics. Preferably, spring elements according to the invention are based on elastomers which are based on cellular polyisocyanate polyaddition products, especially preferably based on cellular polyurethane elastomers which may comprise polycarbamide structures. The term “cellular” means that the cells preferably have a diameter of 0.01 mm to 0.5 mm, especially preferably of 0.01 mm to 0.15 mm.

Especially preferably, the polyisocyanate polyaddition products have at least one of the following material properties: a density according to DIN EN ISO 845 of between 270 and 900 kg/m3, a tensile strength according to DIN EN ISO 1798 of ≧2.0 N/mm2, a ductile yield according to DIN EN ISO 1798 of ≧200% or a tear propagation resistance according to DIN ISO 34-1 B (b) of ≧8 N/mm. In embodiments which are further preferred, a polyisocyanate polyaddition product possesses two, more preferably three of these material properties, and especially preferred embodiments possess all four of said material properties.

Elastomers based on polyisocyanate polyaddition products and their manufacture are generally known and are described in many instances, for example in EP 62 835 A1, EP 36 994 A2, EP 250 969 A1, DE 195 48 770 A1 and DE 195 48 771 A1. Different types of spring elements and methods for producing them are likewise known to a person skilled in the art, for example from the documents DE 101 24 924 A1, DE 10 2004 049 638 A1 or WO 2005/019681 A1.

Spring elements used in damping elements according to the invention are hollow cylindrical structures which have an inner surface area, an outer area and a top end and a bottom end. Preferably, as seen in the longitudinal section, they are essentially conical, the outside diameter in the region of the top end being larger than the outside diameter in the region of the bottom end. The bottom end may be configured differently, for example as a peripheral lip which is directed inward or outward. The shaping and material thickness of the bottom end afford a degree of freedom in the design of spring elements, particularly in order to configure the starting behavior of the spring individually. Corresponding embodiments are known to a person skilled in the art.

The inner surface area may be planar or rough. It may have contour elements which, for example, may extend from the surface area in the direction of the axis and be arranged regularly or irregularly. The actual configuration of the inner surface area depends, for example, on what requirements are placed on the damping element in terms of adhesion to a piston rod or the generation of noise during driving. Furthermore, indentations may be provided in the inner surface area which influence the deformation and damping behavior of the spring element under axial compressive load.

The outer surface area, too, may have a planar or rough configuration. Furthermore, the outer surface area may have contour elements and also indentations or projections. The actual configuration depends, inter alia, on the requirements placed on the deformation and damping behavior of the spring element. Corresponding embodiments are known to a person skilled in the art.

The top end of the spring element is also designated hereafter as the top end face. It may likewise be configured differently, for example as a planar face or as a face with elevations and depressions, depending on the requirement to be met by the damping behavior at the place of installation. The end face too may be designed to be rough. According to the invention, below the top end face, a peripheral depression is located in the inner surface area and is suitable for receiving the supporting ring. A peripheral depression is to be understood as meaning that, as seen in cross section perpendicularly to the longitudinal axis, the diameter of the inner surface area in the radial direction in the depression is larger than it is in that region of the inner surface area which is axially adjacent above it and below it. The depression may be closed continuously, so that the diameter of the inner surface area in each radial direction in the depression is larger than it is in the region which is axially adjacent above it and below it. However, the invention also embraces those components in which the depression is not closed continuously, but, instead, has one or more portions in which the above-described requirement relating to the radii is not fulfilled.

According to the invention, the damping element comprises, furthermore, a supporting ring in addition to the spring element. The supporting ring, as seen in cross section, has on the inside a clearance which is preferably of circular design. The supporting ring may be manufactured from different materials, for example from metals, such as aluminum or aluminum alloys, or from hard plastics, such as thermoplastic polyurethane, polyamide, polyethylene, polypropylene, polystyrene or polyoxymethylene. The supporting ring may also be manufactured from a hard rubber, preferably with a hardness of more than 60 Shore A. A supporting ring made from rubber affords advantages particularly when fatigue strength problems could arise in the case of plastics. The plastics may also be reinforced by fibers, for example by glass fibers. Preferred materials for producing the supporting ring are thermoplastic polyurethane, polyoxymethylene, polypropylene, polyethylene and rubber. They may be produced according to known methods, for example die casting methods for metals, injection molding methods for plastics and vulcanizing methods for rubber.

When inserted into the spring element, the supporting ring causes a reduction in the block dimension. Depending on the actual configuration, it may also cause a stiffening of the damping element in the radial direction. These effects can be influenced in a directed way by the choice of the material and by the dimensioning of the supporting ring.

According to the invention, the supporting ring is mounted in the depression in the inner surface area of the spring element. In the simplest instance, the depression could be configured as an annular groove. However, in a design of this type, there is the problem that the supporting ring may easily jump out of the depression under radial compressive load, for example when the damping element is being assembled or when the damping element is being installed in the construction space in the body of a motor vehicle. It was found that this problem can be solved reliably in that both the depression and the radially outer contour of the supporting ring have a wavy configuration, instead of a circular one.

Wavy means, with regard to the supporting ring, that the outer margin of the supporting ring has regions, the extent of which in the radial direction is greater than the extent of the remaining regions of the outer margin. With regard to the depressions in the inner surface area of the spring element, wavy means that there are regions of the depression, the radial extent of which is greater than that of the remaining regions of the depression. Regions with a greater radial extent are designated hereafter as wave crests and regions with a smaller radial extent as wave troughs. According to the invention, wave crests and wave troughs of the depression in the spring element and of the supporting ring correspond to one another in form, size and arrangement. This means that, in their shape, size and arrangement in the axial, radial and tangential directions, they are configured in such a way that, after the assembly of the damping element, the wave crests of the supporting ring are located in the wave crests of the depression.

The waveform has the advantage, as compared with a circular form, that the circumferential line is longer if the nominal outside diameter is the same. A larger contact area between the supporting ring and the spring element is thereby available. Moreover, the circumferential line is no longer arranged only in the tangential direction, but also at least partially in the radial direction at the transitions of wave crests and wave troughs. This orientation of the circumferential line has the effect, in comparison with the circular form, that the supporting ring, while having the same overlap of its margin, can no longer jump so easily out of the depression when the damping element is subjected to radial compressive load. The supporting ring may be dimensioned such that it is flexible in the radial direction. This property is advantageous particularly when the supporting ring and spring element are mounted by hand, since, in this case, the low radial rigidity has the effect that the supporting ring is not shifted axially when the spring element is compressed radially.

In preferred embodiments, the depression in the inner surface area of the spring element and the outer margin of the supporting ring have in each case from 2 to 10, especially preferably from 4 to 8, particularly 6 wave crests and wave troughs. Furthermore, the wave crests and wave troughs in the depression are preferably arranged so as to be distributed uniformly in the circumferential direction. This is to be understood as meaning that the extents of the wave troughs between adjacent wave crests are essentially identical in the circumferential direction. Of course, depending on the requirement to be met by the damping element, the wave crests and wave troughs may also be distributed non-uniformly. Such a design may be advantageous for damping elements which are subjected not only axially to pressure stress, but also to torsional stress for example in the case of high steering locks, such as may occur in McPherson front axle designs.

In a preferred embodiment of the damping element according to the invention, the ratio of the sum of the circumferential lengths of the wave crests to the wave troughs on the outermost circumference of the supporting ring amounts to at least two. This means that the outermost circumference of the supporting ring is formed in sum of at least two thirds by wave crests, and, in sum, a maximum of one third of the outermost circumference has gaps in the form of wave troughs. In the case of a lower ratio of wave crests to wave troughs on the outermost circumference, there is the risk that the supporting ring loses its radially supporting function, and that, under high radial compressive load, the wave crests of the supporting ring punch into the material of the spring element and thereby damage it.

A supporting ring according to the invention is characterized by three radii, the inner radius, the radius at the foot of the wave troughs and the outer radius. The inner radius designates the radial distance from the axis through the center of the clearance as far as the inner margin of the supporting ring. The outer radius is the corresponding distance from the axis to the outer margin in the region of the wave crests. The radius at the foot of the wave troughs designates the distance from the axis as far as the outer margin of the supporting ring which is formed by the wave troughs.

In a preferred embodiment, the inner radius of the supporting ring is from 1.5 to 4 mm, especially preferably from 2 to 3 mm smaller than the radius of the supporting ring at the foot of the wave troughs. The difference between the inner radius and the radius at the foot of the wave troughs determines the minimum material thickness of the supporting ring in the radial direction. With a view to the most flexible configuration of the supporting ring as possible, a low value of this difference is advantageous. The maximum extent of the supporting ring in the axial direction has an essential influence upon the block dimension increase to be achieved and is selected according to the requirements regarding the block dimension increase. In preferred embodiments, the supporting ring has a maximum extent in the axial direction of from 1 to 30 mm, especially preferably from 3 to 10 mm, particularly from 4 to 7 mm.

A secure hold of the supporting ring in the spring element can be ensured in various ways. If there is a sufficient overlap of the margin of the supporting ring by the depression in the spring element, the outer radius of the supporting ring may be smaller than the corresponding radius of the depression. In a preferred embodiment, the outer radius of the supporting ring is exactly as large as the radius of the depression in the wave crests. In a further preferred embodiment, the outer radius of the supporting ring is larger than the corresponding radius of the depression, so that, after assembly, there is a prestress. The degree of prestress is defined hereafter as the ratio of the difference between the outer radius of the supporting ring in the region of the wave crests and the radius of the depression in the region of the wave crests to the difference between the maximum outer radius of the spring element and the radius of the depression in the region of the wave crests. Preferably, this ratio amounts to from 0% to 20%, especially preferably from 0% to 15%, particularly from 0% to 5%.

Only that material of the spring element which surrounds the supporting ring is critical for the prestress effect. To determine the maximum outer radius, therefore, starting in the axial direction downward from the top end face of the spring element, only a region which corresponds to three times the maximum axial extent of the supporting ring is considered. If, for example, the axial extent of the supporting ring amounts to 5 mm, the maximum outer radius of the spring element is thus determined in the uppermost 15 mm of the spring element.

As mentioned above, for a secure hold of the supporting ring in the depression of the spring element, the overlap of the margin of the supporting ring is important. A further influencing factor is the shape both of the margin of the supporting ring and of the depression in the spring element. The profile of the margin of the supporting ring and the profile of the depression are understood in this context to mean a longitudinal section along the axis through the respective component.

In a preferred embodiment of the invention, the profiles of the supporting ring margin and the depression are essentially rectangular. The corners may in this case be rounded within conventional tolerance dimensions. This embodiment is especially advantageous for the hold of the supporting ring in the spring element. However, this profile makes stringent demands upon the large-scale production of the spring elements. These are usually produced in molds, for example foamed in the case of spring elements based on cellular polyisocyanate polyaddition products. During removal from the mold, damage to the parts may occur, depending on the depth of the rectangular depressions. However, the depressions in the spring element may also be produced by being cut out and milled out after the manufacture of the spring element. This type of manufacture may also be expedient economically precisely for components in small series.

In a further preferred embodiment, the profiles are rounded, in particular semicircularly. The production of profiles of this type is especially advantageous in manufacturing terms. In order to ensure a secure hold of the supporting ring in the spring element, a greater radial overlap of the supporting ring margin by the spring element is necessary, as compared with the angular profiles. This means that the depression has to be larger in the radial direction than in the case of angular profiles, in order to ensure the same hold.

In an especially preferred embodiment, the profile of the outer margin of the supporting ring is configured in the region of the wave crests in such a way as to form, radially outward from the two end-face surfaces of the supporting ring, in each case concave flanks which are connected to one another via a convex tip. This embodiment combines the advantages of the angular and the round profiles, it can be manufactured with a low risk of damage and offers a good hold of the supporting ring along with the comparatively small radial overlap.

In an especially advantageous embodiment, the concave flanks and the convex tip are rounded. The transitions from the concave flanks into the convex tip are designated as turning points. Advantageously, as seen in the axial direction, the distance between the two turning points is greater than the sum of the distances between the turning points and the planes through the axial end faces of the supporting ring.

The overlap of the supporting ring margin by the spring element is preferably configured in such a way that the inner radius of the spring element on the end face in the region of the wave crests is from 1 to 6 mm, especially preferably from 1 to 4 mm, particularly from 1.5 to 3 mm smaller than the outer radius of the supporting ring in the region of the wave crests. The material thickness of the end-face part, overlapping the supporting ring, of the spring element in the axial direction preferably amounts to from 1 to 8 mm, especially preferably from 1.5 to 5 mm, particularly from 2 to 3 mm. The end-face surface of the spring element projects beyond the end-face surface of the supporting ring in the axial direction by preferably from 0.5 to 5 mm, especially preferably from 1 to 3 mm. This projection ensures that, in the event of axial compressive load upon the spring element from below, damping material of the spring element is first compressed before the supporting ring can come into contact with the installation space of a body of a motor vehicle. Rattling noises during driving are thereby markedly reduced or completely avoided.

For manufacturing reasons and for reasons regarding the stability of the spring element, a specific minimum material thickness of the outer wall of the spring element should not be undershot. In preferred embodiments, the material thickness, measured as the distance from the depression in the region of the wave crests to the outer surface area of the spring element, amounts to at least 2 mm, especially preferably to at least 4 mm. What is to be understood as the distance is the shortest range between a point of the depression in the region of a wave crest to a point on the outer surface area.

The spring element may generally assume conventional dimensions, that is to say lengths and diameters, for additional springs. Preferably, the spring element has a height of between 30 mm and 200 mm, especially preferably of between 40 mm and 150 mm. Preferably, the outside diameter of the spring element at its widest point amounts to between 30 mm and 150 mm, especially preferably to between 40 mm and 70 mm. The inside diameter of the cavity of the spring element preferably amounts to between 6 mm and 35 mm. Damping elements, in which the outer radius of the supporting ring in the region of the wave crests is selected so as to be as large as possible in relation to the maximum outer radius of the spring element, are distinguished by especially high stiffening in the upper region of the spring element. A small difference between the inner radius and the radius of the supporting ring at the foot of the wave troughs brings about a reduction in the flexural rigidity of the supporting ring, this reduction affording advantages both for installation and during operation.

According to the invention, the spring element and supporting ring, as components, are manufactured separately and subsequently completed. The advantage of this is that the individual production steps can be carried out efficiently and cost-effectively, and that quality control after the respective manufacture is possible. As compared with the methods in which the components are produced in combination, for example by foam being applied around a prefabricated supporting ring, costs arising due to rejects can thus be minimized.

The damping element according to the invention can be completed by hand in that the supporting ring is pressed into the spring element from above. In a preferred embodiment of the invention, the supporting ring is configured symmetrically in the axial direction. Mounting is thereby simplified, since, in a supporting ring of this type, it does not matter which end face is mounted, facing upward.

The invention is explained in more detail hereafter by means of the drawings, and the drawings are to be understood as being basic illustrations. They do not constitute any restriction of the invention, for example with regard to actual dimensions or configuration variants of components of the damping element. In the drawings:

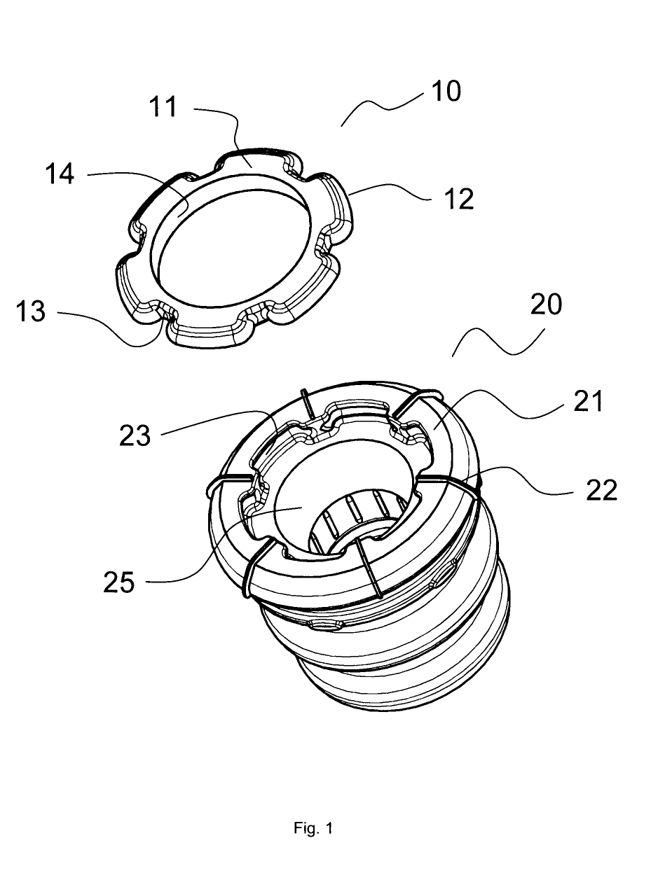

FIG. 1: shows a basic diagram of a damping element according to the invention with a supporting ring and spring element prior to assembly

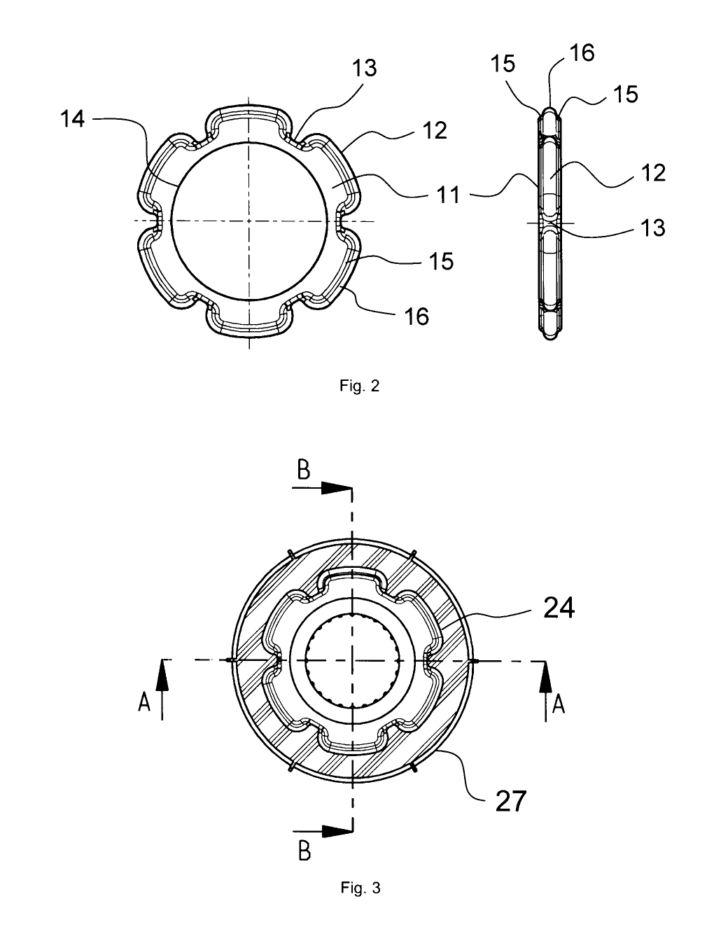

FIG. 2: shows a top view and side view of the supporting ring according to the invention, as shown in FIG. 1

FIG. 3: shows a cross section through a spring element according to the invention in the region of the depression

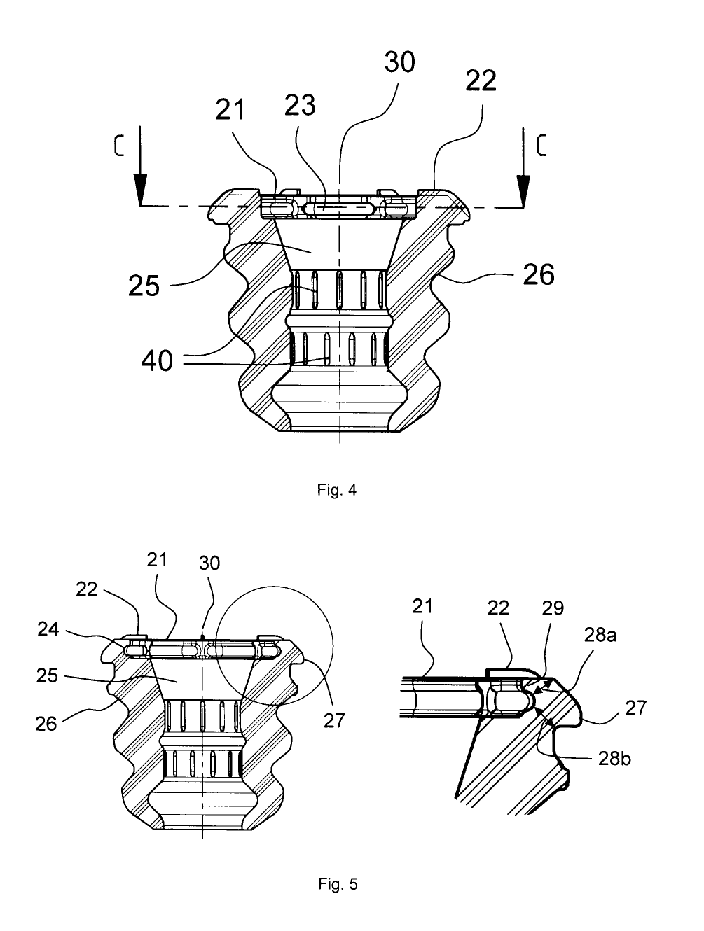

FIG. 4: shows a longitudinal section through a spring element according to the invention (wave troughs)

FIG. 5: shows a longitudinal section through a spring element according to the invention (wave crests) with a view of the depression in the form of a detail

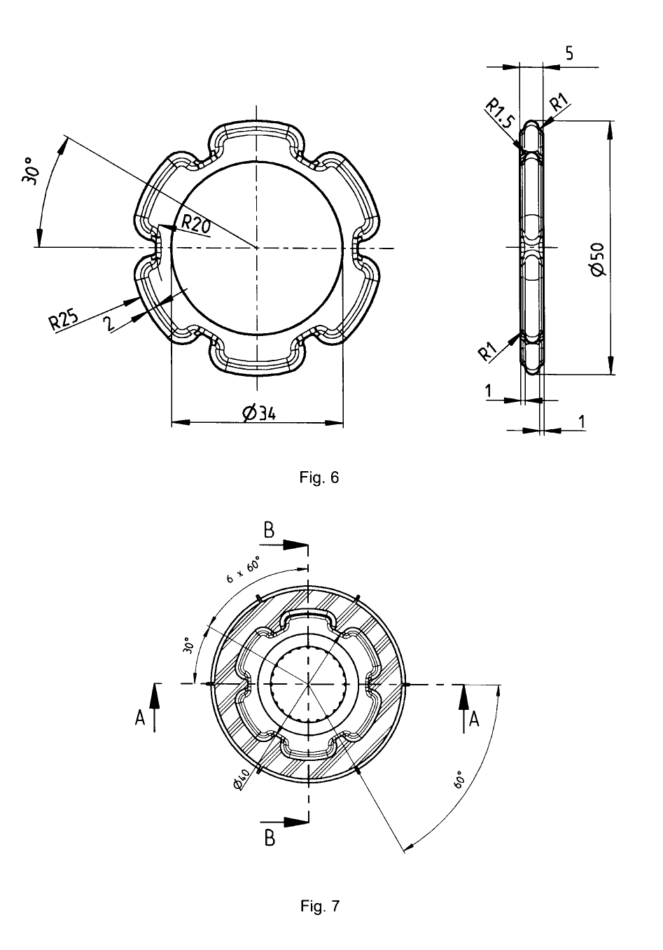

FIGS. 6 to 9: show views and sections of an actual exemplary embodiment

### LIST OF REFERENCE SYMBOLS USED

10 . . . . Supporting ring
11 . . . . End face of the supporting ring
12 . . . . Outer margin of the supporting ring
13 . . . . Foot of a wave trough of the supporting ring
14 . . . . Inner margin of the supporting ring
15 . . . . Concave flank of the marginal profile of the supporting ring
16 . . . . Convex tip of the marginal profile of the supporting ring
20 . . . . Spring element
21 . . . . End face of the spring element
22 . . . . Webs
23 . . . . Depression in the inner surface area of the spring element
24 . . . . Radius of the depression in the region of a wave crest
25 . . . . Inner surface area of the spring element
26 . . . . Outer surface area of the spring element
27 . . . . Maximum outer radius of the spring element
28 . . . . Minimum material thickness of the spring element
29 . . . . End-face overlap
30 . . . . Axis
40 . . . . Contour elements

FIG. 1 shows a basic diagram of a damping element according to the invention with a supporting ring 10 and spring element 20 prior to assembly. The outer margin 12 of the supporting ring is formed by six wave crests. The minimum material thickness of the supporting ring in the radial direction is located between the inner margin 14 and the foot of the respective wave trough 13. The top end face 11 and the bottom end face of the supporting ring are of planar design. The spring element 20 is illustrated in a perspective view of the end face 21 from above. Located on the end face 21 are webs 22 which, in this example, are due to manufacture and, because they are thin, make scarcely any contribution to the damping properties. In other embodiments, however, it is perfectly possible to provide on the end face contour elements which influence the damping properties of the spring element in the axial and/or radial direction. Below the end face 21, the spring element has a wavy depression 23 in the inner surface area 25. The depression 23 corresponds in the number of wave crests and wave troughs and in their dimension and arrangement to those of the supporting ring.

FIG. 2 illustrates the supporting ring according to FIG. 1 in a top view on the end face and in a side view perpendicularly to the end face. The profile of the outer margin 12 of the supporting ring is evident from the side view on the right in FIG. 2. Starting from the end faces 11, the material thickness decreases in each case in the form of a concave flank 15. The maximum extent in the radial direction forms a convex tip 16 which is connected to the two concave flanks 15.

FIG. 3 shows a cross section through a spring element according to the invention in the region of the depression, designated in FIG. 4 as the section C-C. The maximum extent of the depression in the radial direction is given by the radius of the depression 24 in the region of the wave crests. As may be gathered from this illustration and from the sectional plane C-C in FIG. 4, in this exemplary embodiment the maximum outer radius 27 of the spring element is not located in the same plane as the radius of the depression 24, but below it.

FIG. 4 corresponds to a longitudinal section through the spring element along the axis and through two opposite wave troughs. This section is identified in FIG. 3 by A-A. As may be gathered from FIG. 4, in this exemplary embodiment no overlapping of the supporting ring takes place in the wave troughs. The depressions 23 with the corresponding overlaps are located in the regions of the wave crests. However, this is not a mandatory feature. A damping element according to the invention may perfectly well also be configured in such a way that the spring element also overlaps the supporting ring in the region of the wave troughs.

In this example, the inner surface area 25 is shaped conically in the top region of the spring element, with a widening cross section in the direction of the top end face 21. In the middle region, the inner surface area 25 is provided cylindrically with a circular cross section and with a peripheral indentation. It has a plurality of contour elements 40 which project from the surface area 25 in the direction of the axis 30. These contour elements 40 are dimensioned such that, after the damping element has been mounted on a piston rod of a shock absorber of a motor vehicle, in the event of an axial and/or radial relative movement between the piston rod and damping element, the contour elements 40 first come into contact with the piston rod before the inner surface area 25 possibly touches the piston rod. This ensures that squeaking noises during driving are markedly reduced or completely avoided by virtue of the damping element. The actual form and function of the contour elements 40 are to be considered as being illustrative. Other forms and dimensions are also familiar to a person skilled in the art.

FIG. 5 corresponds to a longitudinal section through the spring element along the axis and through two opposite wave crests. This section is designated in FIG. 3 by B-B. In this illustration, the form of the depression and also the overlap of the supporting ring can be seen clearly. The maximum extent in the radial direction of the depression is its radius in the region of a wave crest 24. In the view in the form of a detail on the right-hand side of FIG. 5, the region circled in the longitudinal section on the left-hand side is illustrated enlarged. In the view in the form of a detail, it can be seen clearly that the minimum material thickness between the depression and the outer surface area does not necessarily have to correspond to the distance between the radius of the depression 24 and the maximum outer radius 27. FIG. 5 depicts, by way of example, two further distances 28a and 28b in the form of arrows which, depending on the actual dimension of the spring element, may constitute the minimum material thickness of the spring element. It should be noted that the minimum material thickness 28 is defined with respect to the outer surface area 26, and not with respect to the end face 21. The depression in the spring element is closed off upwardly by an end-face overlap 29. In a similar way to the profile of the supporting ring, the profile of the depression 23 is also formed by two concave flanks and by a convex tip connected to these.

### Example

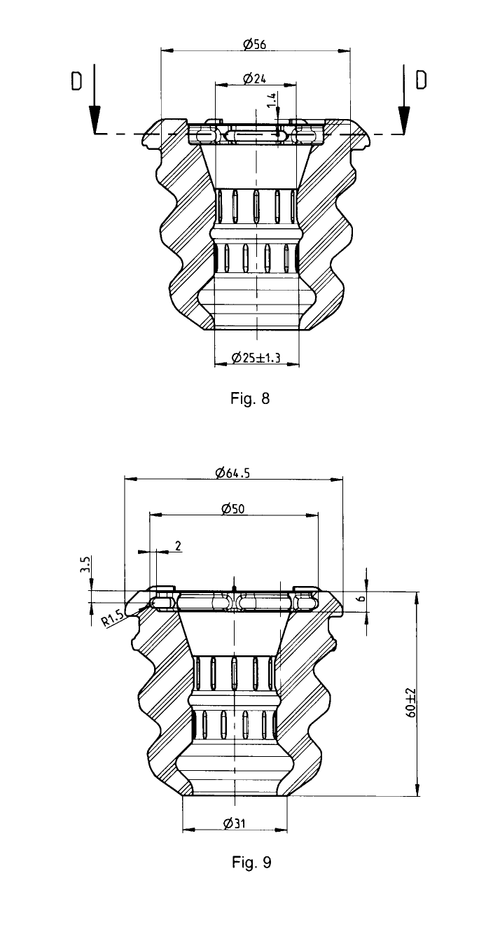

FIG. 6 to FIG. 9 illustrate views and sections of an actual exemplary embodiment of a damping element according to the invention. The spring element is based on a cellular polyisocyanate polyaddition product, and the supporting ring is manufactured from thermoplastic polyurethane. FIG. 6 shows a top view and side view of the supporting ring in a similar way to the illustration in FIG. 2. FIG. 7 depicts a cross section through the spring element, level with the radius of the depression, in a similar way to FIG. 3. This cross section is designated in FIG. 8 by D-D. FIG. 8 shows a longitudinal section along the axis through two wave troughs in a similar way to FIG. 4. This section is designated in FIG. 7 by A-A. FIG. 9 corresponds to a longitudinal section along the axis through two wave crests in a similar way to FIG. 5. This section is designated in FIG. 7 by B-B. The illustrations in FIGS. 6 to 9 are true to scale. The length and diameter particulars in FIGS. 6 to 9 relate to millimeters as the unit used.

1. A damping element comprising a hollow cylindrical spring element (20) and also a supporting ring (10), the spring element (20) having, below the top end face (21), a peripheral depression (23) in the inner surface area (25), and the supporting ring (10) being mounted in this depression (23), wherein both the depression (23) and the outer margin of the supporting ring (12) are designed to be wavy in the radial direction, wave crests and wave troughs of the depression and supporting ring corresponding to one another in form, size and arrangement.

2. The damping element according to claim 1, the depression (23) and the outer margin of the supporting ring (12) in each case having from 2 to 10, preferably from 4 to 8, particularly 6 wave crests and wave troughs.

3. The damping element according to claim 1 or 2, the wave crests and wave troughs being arranged so as to be distributed uniformly in the circumferential direction.

4. The damping element according to at least one of claims 1 to 3, the ratio of the sum of the circumferential lengths of the wave crests to the wave troughs on the outermost circumference of the supporting ring (12) amounting to at least two.

5. The damping element according to at least one of claims 1 to 4, the inner radius of the supporting ring being from 1.5 to 4 mm, preferably from 2 to 3 mm smaller than the radius of the supporting ring at the foot of the wave troughs (13).

6. The damping element according to at least one of claims 1 to 5, the maximum extent of the supporting ring in the axial direction amounting to from 1 to 30 mm, preferably from 3 to 10 mm, particularly from 4 to 7 mm.

7. The damping element according to at least one of claims 1 to 6, the ratio of the difference between the outer radius of the supporting ring (12) in the region of the wave crests and the radius of the depression in the region of the wave crests (24) to the difference between the maximum outer radius of the spring element (27) and the radius of the depression in the region of the wave crests (24) amounting to from 0% to 20%, preferably from 0% to 15%, particularly from 0% to 5%.

8. The damping element according to at least one of claims 1 to 7, the profile of the outer margin of the supporting ring (12) in the region of the wave crests being configured in such a way as to form, radially outward from the two end-face surfaces, in each case concave flanks (15) which are connected to one another via a convex tip (16).

9. The damping element according to at least one of claims 1 to 8, the inner radius of the spring element on the end face in the region of the wave crests being from 1 to 6 mm, preferably from 1 to 4 mm, particularly from 1.5 to 3 mm smaller than the outer radius of the supporting ring in the region of the wave crests.

10. The damping element according to at least one of claims 1 to 9, the material thickness of the end-face part, overlapping the supporting ring, of the spring element (29) in the axial direction amounting to from 1 to 8 mm, preferably from 1.5 to 5 mm, particularly from 2 to 3 mm.

11. The damping element according to at least one of claims 1 to 10, the material thickness, measured as the distance from the depression in the region of the wave crests to the outer surface area of the spring element (26), amounting to at least 2 mm, preferably to at least 4 mm.

12. The damping element according to at least one of claims 1 to 11, the end-face surface of the spring element (21) projecting beyond the end-face surface of the supporting ring (11) by from 0.5 to 5 mm, preferably from 1 to 3 mm.

13. The damping element according to at least one of claims 1 to 12, the spring element (20) being manufactured, based on cellular polyisocyanate polyaddition products.

14. The damping element according to at least one of claims 1 to 13, the supporting ring (10) being manufactured from a hard plastic, particularly based on thermoplastic polyurethane, polyoxymethyene, polypropylene or polyethylene, or from a rubber with a hardness of at least 60 Shore A.

15. A motor vehicle having at least one damping element according to one of claims 1 to 14.
